(19) United States
(12) Patent Application Publication
(10) Pub. No.: US 2008/0158100 A1
(43) Pub. Date: Jul. 3, 2008

(54) DRIVING DEVICE FOR PLASMA DISPLAY PANEL AND PLASMA DISPLAY DEVICE INCLUDING THE SAME

(75) Inventors: Seong-joong Kim, Suwon-si (KR); Suk-ki Kim, Suwon-si (KR)

Correspondence Address: CHRISTIE, PARKER & HALE, LLP, PO BOX 7068, PASADENA, CA, 91109-7068, US

(73) Assignee: SAMSUNG SDI CO., LTD., Suwon-si (KR)

(21) Appl. No.: 11/859,441

(22) Filed: Sep. 21, 2007

(30) Foreign Application Priority Data
Jan. 2, 2007 (KR) 10-2007-0000365

(51) Int. Cl. G09G 3/28

(52) U.S. Cl. 345/60

(57) ABSTRACT

A driving device for a plasma display panel including a plurality of address electrodes extending along a column direction and scan electrodes and sustain electrodes sequentially arranged in and extending along a row direction, the driving device being for applying a driving voltage to the scan electrodes and including: a falling reset unit for applying a gradually falling voltage from Vs voltage to the lowest voltage Vnf to the scan electrodes, during the falling ramp period; and a scan driver being for sequentially applying scan voltage VscL lower than the Vnf voltage by ΔV to the scan electrodes in the address period, wherein the falling reset unit includes a falling ramp switch, a diode, and a Zener diode, which are connected in series.

### CROSS-REFERENCE TO RELATED APPLICATIONS

This application claims priority to and the benefit of Korean Patent Application No. 10-2007-0000365, filed on Jan. 2, 2007, in the Korean Intellectual Property Office, the entire content of which is incorporated herein by reference.

### BACKGROUND

1. Field of the Invention

The present invention relates to a plasma display panel, and more particularly to a driving device for a plasma display panel and a plasma display device including the same.

2. Discussion of Related Art

In a display panel (e.g. plasma display panel) of an alternating current (AC) plasma display device, scan electrodes and sustain electrodes are formed on a first surface in parallel, and address electrodes are formed on a second surface to be perpendicular to the scan and sustain electrodes. Each of the sustain electrodes corresponds to a corresponding one of the scan electrodes, and corresponding ends of the sustain electrodes are connected to each other.

The plasma display device is driven during frames of time. One frame of the plasma display device is divided into a plurality of subfields, each having a brightness weight value. The respective subfields each include a reset period, an address period, and a sustain period.

During the reset period, wall charges formed during a previous sustain discharge are erased and wall charges are set up in order to stably perform a subsequent address discharge. During the address period, turned-on cells (“on cells”) and turned-off cells (“off cells”) of the plasma display panel are selected, and the wall charges are accumulated on the on cells (i.e., the addressed cells). During the sustain period, a sustain discharge is generated in the addressed cells in order to display an image on the display panel of the plasma display device.

During the address period, scan pulses are sequentially applied to the scan electrodes in order to select discharge cells that are used to display an image during the sustain period, and address pulses are applied to the address electrodes such that an address discharge is generated at the addressed cells.

The address discharge is determined by the density of priming particles and the wall voltage according to the wall charges formed in a discharge cell. As the scan pulses are sequentially applied to scan electrodes Y, at an upper end of the display panel, address discharges are generated at discharge cells where the density of priming particles formed in the reset period is relatively high. In contrast, at a lower end of the display panel, address discharges are generated at discharge cells where the density of priming particles formed in the reset period has become relatively low.

Because the magnitude of a wall voltage similarly decreases with time, an address discharge may be delayed by a time that is longer than the width of a corresponding scan pulse due to the lower numbers of priming particles and wall charges in the scan electrodes applied with the scan pulses such that an address discharge either can not be generated or is generated weakly.

### SUMMARY OF THE INVENTION

An aspect of the present invention is directed to providing a driving device for a plasma display panel and a plasma display device including the driving device, the driving device being for supplying a scan driving waveform to a scan electrode. A scan voltage supplied in the address period is lower than a lowest voltage of a falling ramp pulse supplied in the reset period by a certain difference ΔV. As such, stable addressing operations can be performed.

Another aspect of the present invention is directed to providing a driving device for a plasma display panel and a plasma display device including the driving device. In the driving device, a Zener diode is provided in a falling reset unit in order to establish the ΔV difference. The Zener diode is electrically connected in series to a diode having a positive temperature coefficient characteristic to counter an increase in the ΔV difference with respect to an increase in the operating temperature due to the Zener diode having a negative temperature coefficient characteristic.

In one embodiment of the present invention, a driving device for a plasma display panel, which includes a plurality of address electrodes extending along a column direction and a plurality of scan electrodes and a plurality of sustain electrodes extending along a row direction, is for applying a driving voltage to the scan electrodes. The driving device includes: a falling reset unit for applying a falling ramp of the driving voltage during a falling ramp period, the falling ramp decreasing from a first voltage to a second voltage; and a scan driver for sequentially applying a scan voltage of the driving voltage to the scan electrodes during an address period following the falling ramp period, the scan voltage being lower than the second voltage. The falling reset unit includes: a falling ramp switch; a diode coupled with the falling ramp switch, the diode having a first temperature coefficient with respect to a rise in operating temperature; and a Zener diode coupled with the diode in series, the Zener diode having a second temperature coefficient with respect to the rise in the operating temperature. The first temperature coefficient of the diode is opposite to the second temperature coefficient of the Zener diode.

In another embodiment of the present invention, a plasma display device includes a plasma display panel including a plurality of address electrodes extending along a column direction and a plurality of scan electrodes and a plurality of sustain electrodes extending along a row direction; an address electrode driver for applying display data signals to the address electrodes for selecting discharge cells of the plasma display panel; a sustain electrode driver for applying a driving voltage to the sustain electrodes; a scan electrode driver including a falling reset unit for applying a falling ramp voltage to the scan electrodes during a falling ramp period, the falling ramp voltage decreasing from a first voltage to a second voltage and a scan driver for sequentially applying a scan voltage to the scan electrodes during an address period following the falling ramp period, the scan voltage being lower than the second voltage; and a power source unit for providing power to the address electrode driver, the scan electrode driver, and the sustain electrode driver. The falling reset unit of the scan electrode driver includes: a falling ramp switch; a diode coupled with the falling ramp switch, the diode having a first temperature coefficient with respect to a rise in operating temperature; and a Zener diode coupled in series with the diode, wherein the first temperature coefficient of the diode is opposite to a second temperature coefficient of the Zener diode with respect to the rise in the operating temperature.

### BRIEF DESCRIPTION OF THE DRAWINGS

These and/or other aspects and features of the present invention will become apparent and more readily appreciated from the following description of exemplary embodiments, taken in conjunction with the accompanying drawings of which:

FIG. 1 is a block diagram showing a plasma display device according to an embodiment of the present invention;

FIG. 2 is a driving waveform diagram for a plasma display panel according to an embodiment of the present invention;

FIG. 3 is a circuit diagram of a driving device according to a first embodiment of the present invention for generating the driving waveform as shown in FIG. 2;

FIG. 4 is a circuit diagram of a driving device according to a second embodiment for generating the driving waveform as shown in FIG. 2; and

FIG. 5 is a graph showing a temperature characteristic of diode D2 of FIG. 4.

### DETAILED DESCRIPTION

Hereinafter, exemplary embodiments of the present invention will be described with reference to the accompanying drawings.

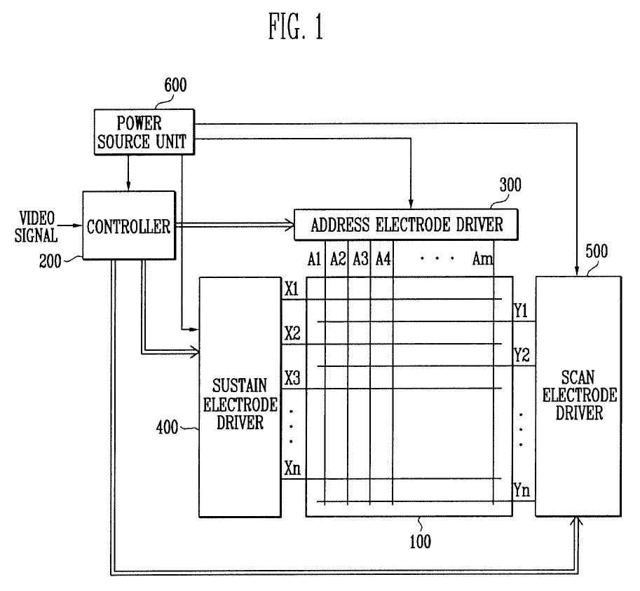

FIG. 1 is a block diagram of a plasma display device according to an embodiment of the present invention.

Referring to FIG. 1, the plasma display device according to one embodiment of the present invention includes a plasma display panel 100, a controller 200, an address electrode driver 300, a sustain electrode driver 400, a scan electrode driver 500, and a power source unit 600.

The plasma display panel 100 includes a plurality of address electrodes A1 to Am extending along a column direction and a plurality of sustain electrodes X1 to Xn and scan electrodes Y1 to Yn extending along a row direction, wherein the sustain electrodes and the scan electrodes are paired with one another. Each of the sustain electrodes X1 to Xn corresponds to a corresponding one of the scan electrodes Y1 to Yn, and corresponding ends of the sustain electrodes are connected to each other.

The plasma display panel 100 also includes a substrate on which the sustain electrodes X1 to Xn and the scan electrodes Y1 to Yn are arranged and a substrate on which the address electrodes A1 to Am are arranged. The two substrates are arranged to face each other to define discharge spaces therebetween so that the scan electrodes Y1 to Yn and the sustain electrodes X1 to Xn are orthogonal to the address electrodes A1 to Am. Here, the discharge spaces located at the crossings of the address electrodes A1 to Am with the sustain and the scan electrodes X1 to Xn and Y1 to Yn form discharge cells. The structure of the plasma display panel 100 as described above is presented herein only by way of example, and it will be appreciated by one skilled in the art that a panel according to embodiments of the present invention may have different structures for which a driving waveform, as will be described in more detail below, can be applied.

The controller 200 outputs an address electrode driving control signal, a sustain electrode X driving control signal and a scan electrode Y driving control signal in response to an external video signal. The controller 200 drives the plasma display device during frames of time, each of which is divided into a plurality of subfields, wherein each subfield includes a reset period, an address period and a sustain period, wherein respective different operations are performed in different periods.

The address electrode driver 300 applies a display data signal to the respective address electrodes for selecting the discharge cells for displaying an image in response to the address electrode driving control signal from the controller 200.

The sustain electrode driver 400 applies a driving voltage to the sustain electrodes X in response to the sustain electrode X driving control signal from the controller 200.

The scan electrode driver 500 applies a driving voltage to the scan electrodes Y in response to the scan electrode Y driving control signal from the controller 200.

The power source unit 600 supplies power required for driving the plasma display device to the controller 200 and the respective drivers 300, 400 and 500.

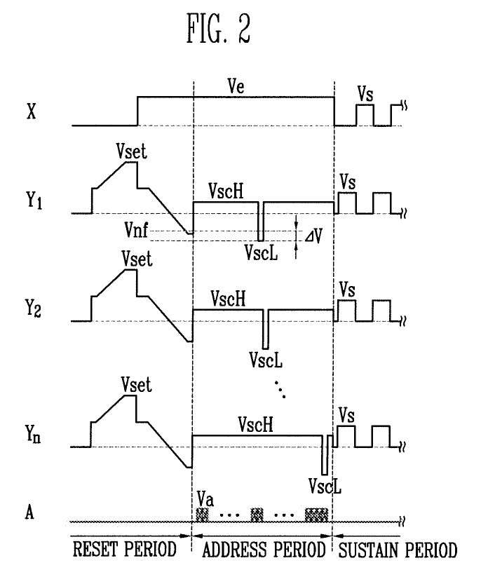

Hereinafter, referring to FIG. 2, the driving waveform to be applied to the address electrodes A1 to Am, the sustain electrodes X1 to Xn and the scan electrodes Y1 to Yn in the respective subfields will be described in more detail. It will be described primarily with reference to a discharge cell defined by one address electrode, one sustain electrode and one scan electrode.

FIG. 2 is a driving waveform diagram for a plasma display panel according to an embodiment of the present invention. For the convenience of description, it will be described with reference to one sustain electrode X and one address electrode A.

In the reset period, a rising ramp pulse is applied to the scan electrode Y. Accordingly, the voltage of the scan electrode Y increases from the Vs voltage to the Vset voltage as the voltage of the sustain electrode X is maintained at 0V.

As a result, negative (−) wall charges are accumulated on the scan electrode Y, and positive (+) wall charges are accumulated on the address electrode A and the sustain electrode X. A weak reset discharge is generated between each of the address electrode A and the sustain electrode X and the scan electrode Y. Thereafter, a falling ramp pulse is applied to the scan electrode Y. Accordingly, the voltage of the scan electrode Y is decreased from the Vs voltage to the Vnf voltage. Here, the address electrode A is applied with a reference voltage (for example, 0V, as shown in FIG. 2), and the sustain electrode X is biased at a Ve voltage. As a result, the negative (−) wall charges accumulated on the scan electrode Y and the positive (+) wall charges accumulated on the sustain electrode X and the address electrode A are erased. A weak reset discharge is generated between the scan electrode Y and the sustain electrode X and between the scan electrode Y and the address electrode A while the voltage of the scan electrode Y is decreased.

Next, in the address period, in order to select the discharge cell, scan pulses having a scan voltage VscL are sequentially applied to the scan electrodes Y and the scan electrodes to which the scan voltage VscL is not applied is biased at a VscH voltage (non-scan voltage). An address pulse having a Va voltage is applied to the address electrode A corresponding to the selected discharge cell among a plurality of discharge cells formed by the scan electrode Y applied with the scan voltage VscL, and the reference voltage (for example, 0V, as shown in FIG. 2) is applied to the non-selected address electrodes A. As a result, positive (+) wall charges are formed on the scan electrode Y, and negative (−) wall charges are formed on the sustain electrode X. An address discharge is generated in the discharge cell formed by the address electrode A applied with the Va voltage and the scan electrode Y applied with the scan voltage VscL. Also, negative (−) wall charges are formed on the address electrode A.

However, when applying the scan pulse to the scan electrode Y in the address period (see, for example, FIG. 2), the scan voltage VscL is lower than the lowest voltage of the falling ramp pulse, that is, the Vnf voltage, by a difference of ΔV.

Accordingly, the difference (|VscL−Va|) between the scan voltage and the address voltage becomes sufficiently large such that the discharge delay time becomes sufficiently short to generate a stable address discharge in the discharge cell corresponding to the scan electrode.

Next, in the sustain period, sustain discharge pulses of the Vs voltage are alternately applied to the scan electrode Y and the sustain electrode X. If the wall voltage is formed between the scan electrode Y and the sustain electrode X via the address discharge in the address period, the sustain discharge is generated in the addressed cell via the wall charge and the Vs voltage. The number of sustain discharge pulses of the Vs voltage applied to the scan electrode Y and to the sustain electrode X correspond to the brightness weight value of the corresponding subfield.

FIG. 3 is a driving circuit diagram according to a first embodiment for generating the driving waveform as shown in FIG. 2.

A body diode may be included for each transistor, wherein an anode of the body diode is connected to a source of the transistor and a cathode of the body diode is connected to a drain of the transistor.

Referring to FIG. 3, the scan electrode driver 500 includes a rising reset unit 501, a falling reset unit 502, a scan driver 503, and a sustain discharger 504.

The scan driver 503 includes a plurality of selection circuits 510 connecting the scan driver 503 to a plurality of scan electrodes Y, respectively. For the convenience of description, only one scan electrode Y and one selection circuit 510 are illustrated in FIG. 3. A capacitive component formed between the scan electrode Y and the corresponding sustain electrode X is illustrated as a panel capacitance Cp. Although the sustain electrode X is connected to a sustain electrode driver 400 (see, for example, FIG. 1), the sustain electrode X is depicted in FIG. 3 as being connected to ground for the convenience of description.

The rising reset unit 501, which includes a diode Dset, a capacitor Cset, and transistors Ypp and Yrr, applies the voltage gradually rising from the Vs voltage to the Vset voltage to the scan electrode Y.

The cathode of the capacitor Cset is connected between a source of the transistor Ypp and a drain of the transistor Yrr, and the source of the transistor Ypp and the drain of the transistor Yrr are connected to a second node N2. Here, when a transistor Yg (to be described in more detail later) is turned on, the capacitor Cset is charged with the Vset-Vs voltage, and, when the transistor Yrr is turned on, the charge of the capacitor Cset generates a weak flow of current from the drain to the source of the transistor Yrr such that the voltage of the panel capacitance Cp gradually rises to the Vset voltage.

The diode Dset is connected between the power source Vset-Vs for supplying the Vset-Vs voltage and each of the drain of the transistor Yrr and the capacitor Cset such that it blocks the flow of current toward the power source Vset-Vs.

The falling reset unit 502, which includes transistors Ynp and Yfr, and a Zener diode D1, applies a voltage gradually decreasing from the Vs voltage to a Vnf voltage to the scan electrode Y.

The drain of the transistor Yfr, which serves as a falling ramp switch, is connected to an anode electrode of the Zener diode D1, the source thereof is connected to a power source supplying the scan voltage VscL, and the cathode electrode of the Zener diode D1 is connected to a first node N1. That is, the falling ramp switch Yfr and the Zener diode D1 are connected between the power source supplying the scan voltage VscL and the first node N1 in series.

As described above, in the embodiment of the present invention, the lowest voltage Vnf of the falling ramp (see, for example, FIG. 2) is implemented via the scan voltage VscL applied to the scan driver 503.

Here, the Vnf voltage has the value (Vnf=VscL+Vz), where Vz is a breakdown voltage of the Zener diode D1 connected in series with the falling ramp switch Yfr, which is connected to the scan voltage VscL. Here, the breakdown voltage Vz of the Zener diode D1 serves as the difference between the Vnf voltage and the VscL voltage, that is, ΔV.

In other words, in the embodiment of the present invention, the Zener diode D1 is provided such that the lowest voltage Vnf of the falling ramp has a substantially constant potential (VscL+ΔV) with respect to the potential of the scan voltage VscL.

By way of example, in the case of a 42″ high-definition (HD) grade display, it is desirable that the ΔV is in a range between 24V and 30 V, and accordingly, the breakdown voltage Vz of the Zener diode should be between 24V and 30 V.

As such, when the falling ramp switch Yfr is turned on, the voltage applied to the first node N1, i.e., Vnf, is the sum of the scan voltage VscL applied to the source of the falling ramp switch Yfr and the breakdown voltage Vz of the Zener diode D1.

Also, the falling ramp switch operates to provide a weak flow of current from the drain to the source such that the voltage of the scan electrode Y is gradually reduced to the Vnf voltage. Here, the transistor Ynp blocks the flow of current along a path between ground GND and the transistor Yfr (via the transistor Yg and the transistor Ypp), which might otherwise be formed when the Vnf voltage is negative.

As described above, the embodiment of the present invention provides two output voltages Vnf and VscL having different levels, from the same power source (i.e., the power source providing the VscL voltage), which is connected to both the falling reset unit 502 and the scan driver 503. As such, a more stable addressing operation can be performed. In addition, board size and manufacturing costs are reduced because a separate power source is not required.

The scan driver 503, which includes a selection circuit 510, a diode Dsch, a capacitor Csch and a transistor YscL serving as a scan driving switch, sequentially applies the scan voltage VscL to the scan electrodes Y.

The selection circuits 510 are implemented using IC and connected to the respective scan electrodes Y1-Yn in an IC shape so that the scan driver 503 can sequentially select one of a plurality of scan electrodes Y1-Yn in the address period, and the driving circuit of the scan electrode driver 500 is commonly connected to the scan electrode Y1-Yn via the selection circuit 510.

The selection circuit 510 includes transistors Sch and Scl. The source of the transistor Sch and the drain of the transistor Scd are connected to the scan electrode Y defining the panel capacitance Cp, and the source of the transistor Scl is connected to the first node N1.

The capacitor Csch is connected between the drain of the transistor Sch and the first node N1, and the diode Dsch is connected between the power source VscH supplying the VscH voltage and both the capacitor Csch and the drain of the transistor Sch. A first terminal of the capacitor Csch is connected to the drain of the transistor Sch, and a second terminal thereof is connected to the first node N1. The transistor YscL is connected between the first node N1 and the power source supplying the scan voltage VscL.

In other words, the VscH voltage is applied to the non-selected scan electrodes Y by using voltage charged in the capacitor Csch when the transistor Sch is turned on in the address period, and the scan voltage VscL is applied to the selected scan electrode Y by turning on the transistor Scl.

The sustain discharger 504, which includes transistors Ys and Yg, applies a Vs voltage and a 0V voltage to the scan electrode Y. The drain of the transistor Ys is connected to the power source Vs supplying the Vs voltage, and the source thereof is connected to a third node N3. The drain of the transistor Yg is connected to the third node N3 and the source thereof is connected to the power source (i.e., GND) supplying the 0V voltage. A power recovery circuit for recovering reactive power formed via a sustain discharge pulse in the sustain period and for reusing the power may be connected to the third node N3. Such a power recovery circuit has been proposed by L. F. Weber (see U.S. Pat. Nos. 4,866,349 and 5,081,400).

In the embodiment shown in FIG. 3, in order to make the magnitudes of the Vnf voltage and the VscL voltage different, that is, to make the Vnf voltage have a magnitude lower than the VscL voltage by a potential difference ΔV such that a more stable addressing operation can be performed, a Zener diode D1 is provided in the falling reset unit.

However, the temperature characteristic of the Zener diode has a negative (−) temperature coefficient when the breakdown voltage Vz is lower than about 5V to 6 V, and it has a positive (+) temperature coefficient when the breakdown voltage Vz is higher than about 5V to 6V.

Accordingly, in an embodiment of the present invention, where a breakdown voltage Vz of Zener diode D1 (i.e., ΔV) is between 24V and 30V, the ΔV potential rises as the operating temperature increases. Operating temperature as used herein refers to the temperature of the display panel while in operation.

In other words, in view of the above described characteristic, the value of the breakdown voltage Vz of the Zener diode D1 provided in order to perform a more stable addressing operation, that is, to improve the discharge characteristic, rises as the operating temperature increases, causing a disadvantage where the discharge characteristic becomes deteriorated when the display device provided with the Zener diode is at a high operating temperature.

Therefore, an aspect of an embodiment of the present invention is directed towards improving the high temperature discharge characteristic of the display device by stabilizing the ΔV potential regardless of operating temperature by compensating for the positive (+) temperature coefficient characteristic of the Zener diode D1.

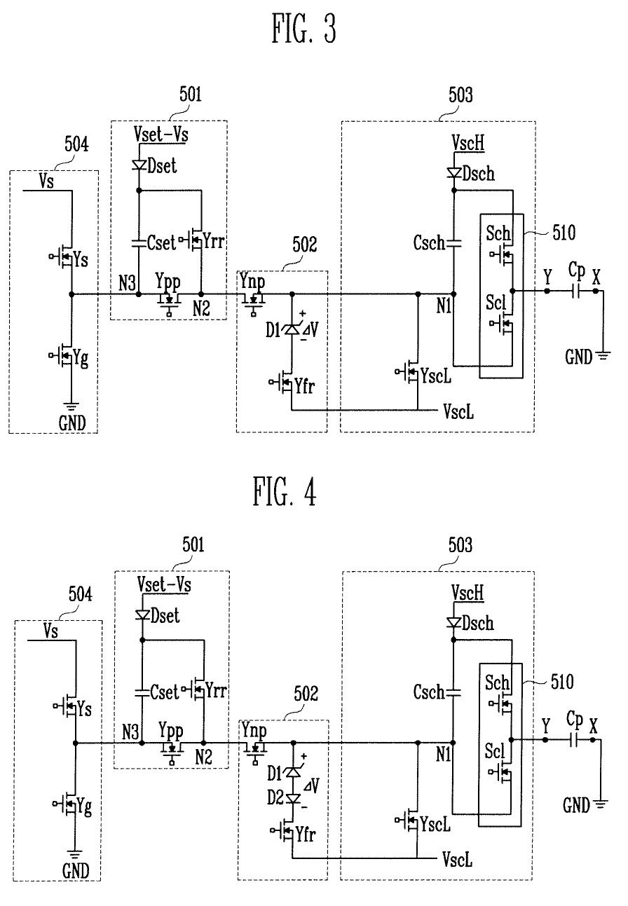

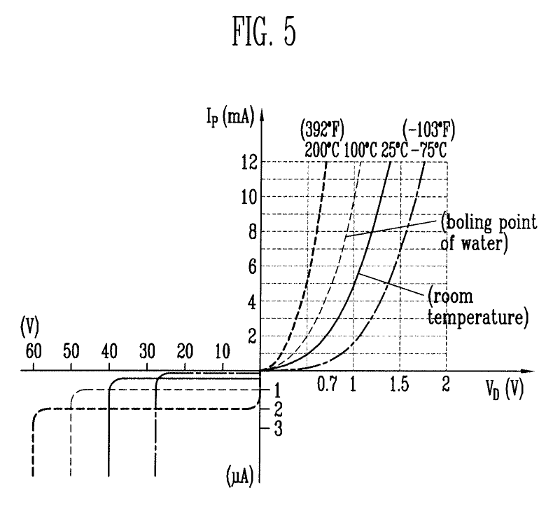

FIG. 4 is a circuit diagram of a driving device according to a second embodiment for generating the driving waveform as shown in FIG. 2, and FIG. 5 is a graph showing the temperature characteristic of the diode D2 of FIG. 4.

Some elements shown in FIG. 4 are similar to corresponding elements shown in FIG. 3, and, for convenience of description, description of such elements will not be repeated below.

Referring to FIG. 4, since the falling ramp switch Yfr of the falling reset unit 502 and the scan driving switch YscL of the scan driver 503 share a common power source line, the scan electrode driver 500 is applied with the scan voltage VscL from the corresponding power source unit through the common power source line, and a diode D2 is connected between the falling ramp switch Yfr and the Zener diode D1 in order to compensate for (or counter) the positive temperature coefficient characteristic of the Zener diode.

In other words, the source electrode of the transistor Yfr (the falling ramp switch) is connected to the power source line supplying the scan voltage VscL, the drain thereof is connected to the cathode of the diode D2, and the anode of the diode D2 is connected to the anode of the Zener diode D1. The cathode electrode of the Zener diode D1 is connected to the first node N1.

Therefore, the falling ramp switch Yfr, the diode D2 and the Zener diode D1 are connected between the power source supplying the scan voltage VscL and the first node N1 in series.

Here, as described above, the Zener diode D1 has a positive temperature coefficient characteristic when a breakdown voltage Vz thereof is 24V or higher, and the diode D2 has a negative temperature coefficient characteristic in order to prevent the ΔV potential from varying with temperature due to the characteristic of the Zener diode D1.

Referring to FIG. 5, the diode D2 has a decreasing forward voltage as operating temperature increases, that is, a negative temperature coefficient characteristic such that the value of the breakdown voltage Vf of the diode D2 decreases as temperature increases.

Therefore, the temperature characteristic of the diode D2 is opposite to the positive temperature coefficient of the Zener diode D1, where the Vz voltage increases as the temperature rises. As shown in FIG. 4, by connecting the Zener diode D1 having the positive temperature coefficient to the diode D1 having the negative temperature coefficient, the breakdown voltage Vf of the diode D1 falls by an amount as much as an amount by which the breakdown voltage Vz of the Zener diode D1 increases when the operating temperature rises such that the ΔV potential (that is, Vz+Vf) can be maintained to be substantially constant.

In other words, by connecting the Zener diode D1 and the diode D2 between the falling ramp switch Yfr and the first node N1 in series, the Vnf voltage applied to the first node N1 and to the scan electrode in the address period via the falling ramp can be uniformly maintained at a potential higher than the scan voltage VscL by ΔV potential (Vz+Vf) regardless of a change in the operating temperature.

Therefore, the plasma display panel including the diode D2 according to the second embodiment of the present invention can maintain the ΔV potential (Vz+Vf) to be substantially constant even when operating at a high temperature. As such, it is capable of increasing the yield by improving the high temperature discharge characteristic.

As such, the ΔV can be maintained to be substantially constant even when the operating temperature rises, so that the discharge margin can be further secured. This way, the production rate of good products may be increased or maximized by reducing a high temperature discharge defect rate.

Although a few embodiments of the present invention have been shown and described, it would be appreciated by those skilled in the art that changes might be made in the embodiments without departing from the principles and spirit of the invention, the scope of which is defined in the claims and their equivalents.

What is claimed is:

1. A driving device for a plasma display panel including a plurality of address electrodes extending along a column direction and a plurality of scan electrodes and a plurality of sustain electrodes extending along a row direction, the driving device for applying a driving voltage to the scan electrodes and comprising:
a falling reset unit for applying a falling ramp of the driving voltage during a falling ramp period, the falling ramp decreasing from a first voltage to a second voltage; and
a scan driver for sequentially applying a scan voltage of the driving voltage to the scan electrodes during an address period following the falling ramp period, the scan voltage being lower than the second voltage,
wherein the falling reset unit comprises:
a falling ramp switch;
a diode coupled with the falling ramp switch, the diode having a first temperature coefficient with respect to a rise in operating temperature; and
a Zener diode coupled with the diode in series, the Zener diode having a second temperature coefficient with respect to the rise in the operating temperature, wherein the first temperature coefficient of the diode is opposite to the second temperature coefficient of the Zener diode.

2. The driving device for the plasma display panel as claimed in claim 1, wherein the falling ramp switch of the falling reset unit and a scan driving switch of the scan driver are coupled to a power source line for supplying the scan voltage.

3. The driving device for the plasma display panel as claimed in claim 2, wherein a source electrode of the falling ramp switch is electrically connected to the power source line, a drain electrode of the falling ramp switch is electrically connected to a cathode of the diode, and an anode of the diode is electrically connected to an anode of the Zener diode.

4. The driving device for the plasma display panel as claimed in claim 1, wherein the Zener diode has a breakdown voltage in a range from 24V to 30V.

5. The driving device for the plasma display panel as claimed in claim 1, wherein the first temperature coefficient of the diode is adapted to control a difference between the second voltage and the scan voltage to be substantially constant with respect to the rise in the operating temperature.

6. A plasma display device comprising:
a plasma display panel comprising a plurality of address electrodes extending along a column direction and a plurality of scan electrodes and a plurality of sustain electrodes extending along a row direction;
an address electrode driver for applying display data signals to the address electrodes for selecting discharge cells of the plasma display panel;
a sustain electrode driver for applying a driving voltage to the sustain electrodes;
a scan electrode driver comprising a falling reset unit for applying a falling ramp voltage to the scan electrodes during a falling ramp period, the falling ramp voltage decreasing from first voltage to a second voltage and a scan driver for sequentially applying a scan voltage to the scan electrodes during an address period following the falling ramp period, the scan voltage being lower than the second voltage; and
a power source unit for providing power to the address electrode driver, the scan electrode driver, and the sustain electrode driver,
wherein the falling reset unit of the scan electrode driver comprises:
a falling ramp switch;
a diode coupled with the falling ramp switch, the diode having a first temperature coefficient with respect to a rise in operating temperature; and
a Zener diode coupled in series with the diode, wherein the first temperature coefficient of the diode is opposite to a second temperature coefficient of the Zener diode.

7. The plasma display device as claimed in claim 6, wherein the falling ramp switch of the falling reset unit and a scan driving switch of the scan driver are coupled to a power source line for supplying the scan voltage.

8. The plasma display device as claimed in claim 7, wherein a source electrode of the falling ramp switch is electrically connected to the power source line, a drain electrode of the falling ramp switch is electrically connected to a cathode of the diode, and an anode of the diode is electrically connected to an anode of the Zener diode.

9. The plasma display device as claimed in claim 6, wherein the Zener diode has a breakdown voltage in a range from 24V to 30V.

10. The plasma display device as claimed in claim 6, wherein the first temperature coefficient of the diode is adapted to control a difference between the second voltage and the scan voltage to be substantially constant with respect to the rise in the operating temperature.

11. A driving device for a plasma display panel including a plurality of address electrodes extending along a column direction and a plurality of scan electrodes and a plurality of sustain electrodes sequentially extending along a row direction, the driving device for applying a driving voltage to the scan electrodes and comprising:
a falling reset unit for supplying a falling ramp of the driving voltage during a falling ramp period, the falling ramp decreasing from a first voltage to a second voltage; and
a scan driver for sequentially applying a scan voltage of the driving voltage during an address period following the falling ramp period, the scan voltage being lower than the second voltage,
wherein the falling reset unit comprises:
a falling ramp switch;
a Zener diode having a breakdown voltage; and
countering means coupled between the falling ramp switch and the Zener diode, the countering means being for maintaining a difference between the second voltage and the scan voltage to be substantially constant with respect to a rise in operating temperature.

12. The driving device of claim 11,
wherein the Zener diode has a first temperature characteristic with respect to the rise in the operating temperature, and
wherein the countering means has a second temperature characteristic with respect to the rise in the operating temperature, the second temperature characteristic being for countering a variance of the breakdown voltage of the Zener diode according to the first temperature characteristic.

13. The driving device of claim 11,
wherein the breakdown voltage of the Zener diode is in a range from 24V to 30V.

14. The driving device of claim 11,
wherein the countering means comprises a diode.

15. The driving device of claim 14,
wherein the diode has a cathode terminal and an anode terminal,
wherein the cathode terminal of the diode is coupled with the falling ramp switch, and
wherein the anode terminal of the diode is coupled with an anode terminal of the Zener diode.
